(19) United States
(12) Patent Application Publication
(10) Pub. No.: US 2017/0138449 A1
(43) Pub. Date: May 18, 2017

(54) SHIFT ON THE FLY TRANSMISSION

(71) Applicant: TEAM Industries, Inc., Bagley, MN (US)

(72) Inventors: John E. Hamrin, Bemidji, MN (US); Jeffrey Joseph Haack, Bemidji, MN (US); Bruce H. Younggren, Bemidji, MN (US); Brandon P. Lenk, Shevlin, MN (US); Gregory L. Maki, Solway, MN (US)

(21) Appl. No.: 15/352,857

(22) Filed: Nov. 16, 2016

Related U.S. Application Data
(60) Provisional application No. 62/255,965, filed on Nov. 16, 2015.

(51) Int. Cl. F16H 37/02; F16H 3/00

(52) U.S. Cl. CPC F16H 37/021; F16H 3/001

(57) ABSTRACT

A shift on the fly transmission is provided. The shift on the fly transmission includes a continuously variable transmission portion, a discrete transmission portion, at least one input shaft and a disconnect clutch. The continuously variable transmission portion is operationally coupled to receive torque from an engine. The discrete transmission portion includes a gear assembly. The at least one input shaft is operationally coupled to an output of the continuously variable transmission portion. The disconnect clutch operationally couples the at least one input shaft to the discrete transmission portion. The disconnect clutch is further configured to selectively decouple torque from the at least one input shaft to the discrete transmission portion during a range ratio shift of the discrete transmission portion.

### CROSS-REFERENCE TO RELATED APPLICATIONS

This application claims priority to U.S. Provisional Application Ser. No. 62/255,965, same title herewith, filed on Nov. 16, 2015, which is incorporated in its entirety herein by reference.

### BACKGROUND

Vehicles such as, but not limited to, recreational vehicles including all-terrain vehicles (ATVs) and utility task vehicles (UTVs) implement belt operated continuously variable transmission (CVT) or dual clutch transmissions. Vehicles that implement CVT typically require the vehicle to stop before shifting between low range and high gear range. However, it is not uncommon for operators to not come to a complete stop when shifting between low and high gear ranges. Some newer systems allow for shifting from low to high at higher speeds however noise, vibration and harness (NVH) factors and durability are very poor.

In a typical CVT system, to make a shift from low to high, the throttle is let off and a shift handle is moved from low to high. When this occurs a shift dog is disengaged from low into a short neutral band and then is slide into high. Because of a gear ratio difference between low and high, the high gear shift dog is going at a reverse shaft revolutions per minute (RPM) while the high gear is going at a different RPM. The RPM difference is dictated by the ratio difference between high and low and the input shaft RPM. An associated second clutch is also going at low gear RPM upon disengagement of low. Because of this RPM difference, there is a loud audible “clunk” that occurs between shift dogs when high is engaged. Once the shift happens, the secondary clutch, which was connected to the vehicle ground speed at a low transmission ratio, is now connected to ground in high transmission ratio. The energy required to change the clutch RPM results in the undesirable clunk when making this shift.

For the reasons stated above and for other reasons stated below which will become apparent to those skilled in the art upon reading and understanding the present specification, there is a need in the art for and effective and efficient shift on the fly transmission.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a shift on the fly transmission is provided. The shift on the fly transmission includes a continuously variable transmission portion, a discrete transmission portion, at least one input shaft and a disconnect clutch. The continuously variable transmission portion is operationally coupled to receive torque from an engine. The discrete transmission portion includes a gear assembly. The at least one input shaft is operationally coupled to an output of the continuously variable transmission portion. The disconnect clutch operationally couples the at least one input shaft to the discrete transmission portion. The disconnect clutch is further configured to selectively decouple torque from the at least one input shaft to the discrete transmission portion during a range ratio shift of the discrete transmission portion.

Further in an embodiment, the at least one input shaft further includes a first input shaft and a second input shaft. The first input shaft is operationally coupled to an output of the continuously variable transmission portion. The second input shaft is operationally coupled to the discrete transmission portion and the disconnect clutch operationally couples the at least one input shaft to the second input shaft.

Further in an embodiment, the first input shaft is an inner input shaft and the second input shaft is an outer input shaft. The inner input shaft is received within the outer input shaft.

Further in an embodiment, the disconnect clutch includes a clutch pack.

Further in an embodiment, the shift on the fly transmission further includes a shift drum and disengagement fork. The shift drum has a disconnect track. The disengagement fork is operationally engaged with the disconnect track of the shift drum. The disengagement fork is further configured to activate the disconnect clutch.

Further in an embodiment, the disengagement fork is pivotally coupled to the at least one input shaft.

Further in an embodiment the continuously variable transmission portion includes a drive clutch, a driven clutch and belt. The drive clutch is operationally coupled to receive the torque from the engine in the form of a rotational input. The at least one input shaft is operationally coupled to the driven clutch. The belt is engaged between the drive clutch and the driven clutch to rotationally couple the drive clutch to the driven clutch.

Further in an embodiment the gear assembly of the discrete transmission portion further includes an input shaft high gear assembly and an input shaft low gear assembly.

Further in an embodiment the input shaft high gear assembly includes an input shaft high gear, a reverse shaft high gear and an engagement dog. The input shaft low gear assembly includes an input shaft low gear, a reverse shaft low gear and an engagement dog. Further the gear assembly includes a reverse shaft that is operationally coupled between the gear assembly and the final drive.

In another embodiment a shift on the fly transmission is provided. The shift on the fly transmission includes a drive clutch, a driven clutch, a belt, an inner input shaft, a discrete transmission portion, an outer input shaft and a disconnect clutch. The drive clutch is operationally coupled to receive torque from an engine in the form of a rotational input. The belt is engaged between the drive clutch and the driven clutch to rotationally couple the drive clutch to the driven clutch. The inner input shaft is operationally coupled to the driven clutch. The discrete transmission portion has a gear assembly. The outer input shaft is operationally coupled to the discrete transmission. The disconnect clutch operationally couples the inner input shaft to the outer input shaft. The disconnect clutch is configured to selectively decouple torque from the inner input shaft to the outer input shaft during a range ratio shift of the discrete transmission portion.

Further in an embodiment, the discrete transmission portion further includes a shift drum, a disconnect shift collar and a disengagement fork. The shift drum has a disconnect track. The disconnect shift collar is operationally engaged in the disconnect track of the shift drum. A push rod is operationally coupled to the disconnect shift collar. The disengagement fork is operationally engaged with the push rod. The disengagement fork is further configured and arranged to activate the disconnect clutch.

Further in an embodiment, the disconnect clutch further includes an inner ring clutch basket, an outer clutch basket and a clutch pack. The inner ring clutch basket is operationally coupled to the outer input shaft. The outer clutch basket is operationally coupled to the inner input shaft. The clutch pack includes a plurality sandwiched clutch plates and friction plates. The clutch plates are engaged with the inner ring basket and the friction plates are engaged with the outer clutch basket. Wherein activation of the disconnect clutch reduces friction between the sandwiched clutch plates and friction plates.

Further in an embodiment, the shift on the fly transmission includes at least one pressure plate that is configured and arranged to operationally engage the clutch pack and a plurality of compression springs. The compression springs are operationally engaged with the at least one pressure plate to compress the sandwiched clutch plates and friction plates of the clutch pack. The disengagement fork is configured to selectively compress the plurality of springs to disengage the disconnect clutch.

In another embodiment, a vehicle having a shift on the fly transmission system is provided. The vehicle includes an engine to provide torque, a continuously variable transmission portion, a discrete transmission portion. At least one input shaft, a disconnect clutch, a final drive and at least one vehicle wheel. The continuously variable transmission portion is operationally coupled to the engine to receive the torque. The discrete transmission portion has a gear assembly. The at least one input shaft is operationally coupled to the continuously variable transmission portion. The disconnect clutch operationally couples the at least one input shaft to the discrete transmission portion. The disconnect clutch is further configured and arranged to selectively decouple torque from the at least one input shaft to the discrete transmission portion. The final drive assembly is operationally coupled to an output of the discrete transmission and the at least one vehicle wheel operationally coupled to the final drive assembly.

Further in an embodiment, the at least one input shaft further includes a first input shaft, a second input shaft and a disconnect clutch. The first input shaft is operationally coupled to an output of the continuously variable transmission portion. The second input shaft is operationally coupled to the discrete transmission portion and the disconnect clutch is operationally coupling the at least one input shaft to the second input shaft.

Further in an embodiment, the first input shaft is an inner input shaft and the second input shaft is an outer input shaft. The inner input shaft is received within the outer input shaft.

Further in an embodiment, the vehicle further includes a shift drum, a disconnect shift collar, a push rod and a disengagement fork. The shift drum has a disconnect track. The disconnect shift collar is operationally engaged in the disconnect track of the shift drum. The push rod is operationally coupled to the disconnect shift collar and the disengagement fork is operationally engaged with the push rod. The disengagement fork is further configured and arranged to activate the disconnect clutch.

Further in an embodiment, the continuously variable transmission includes a drive clutch, a driven clutch and a belt. The drive clutch is operationally coupled to receive the torque of the engine in the form of a rotational input. The at least one input shaft is operationally coupled to the driven clutch. The belt is engaged between the drive clutch and the driven clutch to rotationally couple the drive clutch to the driven clutch.

Further in an embodiment, the gear assembly includes an input shaft high gear assembly and an input shaft low gear assembly.

Further in an embodiment, the input shaft high gear assembly includes an input shaft high gear, a reverse shaft high gear and a high engagement dog/synchronizer. The input shaft low gear assembly includes an input shaft low gear, reverse shaft low gear and a low engagement dog/synchronizer. The gear assembly further includes a reverse shaft that is operationally coupled between the gear assembly and the final drive.

### BRIEF DESCRIPTION OF THE DRAWINGS

The present invention can be more easily understood and further advantages and uses thereof will be more readily apparent, when considered in view of the detailed description and the following figures in which:

FIG. 1 is a block diagram of a vehicle of one embodiment of the present invention;

FIG. 2 is a side perspective view of an assembled CVT of an embodiment of the present invention;

FIGS. 3A through 3C are exploded views of a discrete transmission portion of the CVT of FIG. 2;

FIG. 4 is a partial side perspective view of the discrete transmission portion of the CVT of FIG. 2 illustrating shift on the fly features in an embodiment;

FIG. 5 is a partial side perspective view of the discrete transmission portion of the CVT of FIG. 2 illustrating shift on the fly features of an embodiment;

FIG. 6 is a partial side perspective view of discrete transmission portion of the CVT of FIG. 2 illustrating shift on the fly features of an embodiment;

FIG. 7 is a partial side perspective view of the discrete transmission portion of FIG. 6 viewed at a slightly different angle;

FIG. 8 is a partial cross-sectional first side view of the discrete transmission portion of the CVT of FIG. 2 showing the driven clutch operationally coupled to the inner input shaft in an embodiment;

FIG. 9 is a partial cross-sectional second side view of the discrete transmission portion of the CVT of FIG. 2 showing the driven clutch operationally coupled to the inner input shaft of an embodiment;

FIG. 10 is a partial cross-sectional top view of a portion of the disconnect clutch of the embodiment of FIG. 2;

FIG. 11 is a partial cross-sectional close up view of a portion of an activation assembly for the disconnect clutch of the embodiment of FIG. 2;

FIG. 12 is a partial cross-sectional close up view of a portion of the discrete transmission portion of the CVT of FIG. 2 highlighting the shift drum of an embodiment;

FIG. 13 is a cross-sectional view of the partial components of the shift on the fly system of the embodiment of FIG. 2;

FIG. 14 is a cross-sectional view of a portion of a shift on fly system implementing a single input shaft of one embodiment of the present invention;

FIG. 15 is a side perspective view of the shift on the fly system of the embodiment of FIG. 14; and

FIG. 16 is a cross-sectional side view of a portion of the shift on the fly system of the embodiment of FIG. 14.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a vehicle that allows an operator to shift from a high gear to a low gear or from a low gear to a high gear without having to stop. Embodiments take some of the functions of a manual transmission (i.e. smooth shifting between gears) and combines them with the benefits of a belt driven continuously variable transmission (CVT). This results in a transmission system with responsive ratio optimization as well as fast and smooth acceleration across a wide speed range allowing the engine to stay at a maximum horse power during acceleration without shifting between gears (benefits of the CVT) while having features of shifting between a low range and a high range. This system is very beneficial in situations where a low gear is needed to climb a hill, get out of hole, start pulling something, etc. but then once over the hill, out of the hole or after the initial start of pulling, smoothly shifting from low gear to high gear without slowing down all while maintaining CVT functions. Moreover, the transmission system also allows driving in high gear range at a relatively high speed and shifting down into low gear range to go up a steep hill without coming to a stop or near stop to shift into low gear. In an example embodiment, a vehicle with a continuously variable transmission CVT implements a disconnect clutch as described below in detail to allow an operator to shift from a high gear to a low gear or from a low gear to a high gear without having to stop.

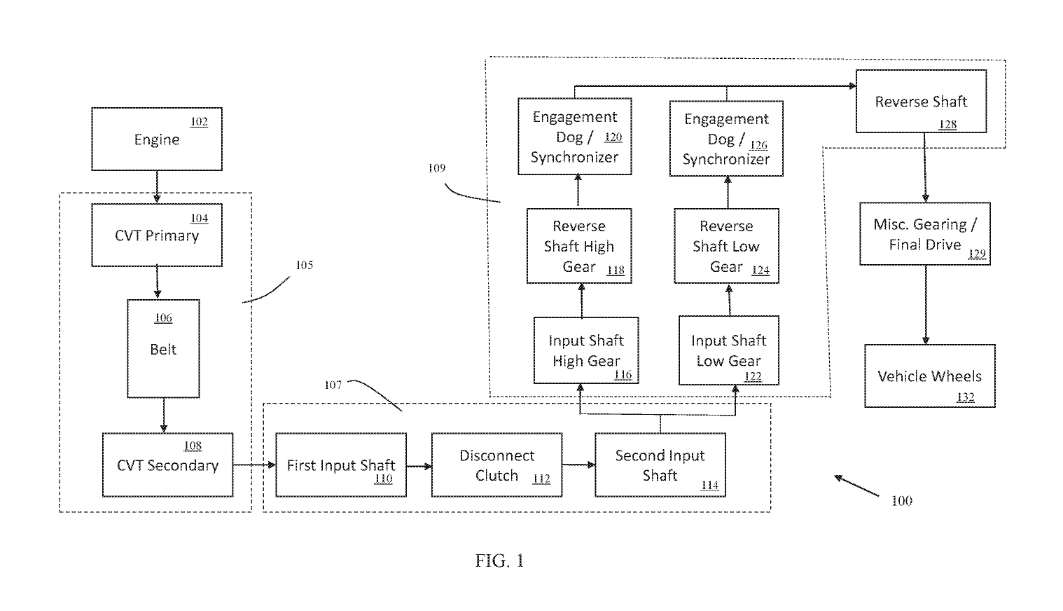

Referring to FIG. 1, a block diagram of vehicle 100 of an embodiment is shown. The vehicle block diagram 100 of FIG. 1 illustrates how torque generated by the engine 102 is provided to the miscellaneous gearing/final drive train 129 and the vehicle wheels 132. Embodiments of the present invention implement a CVT that includes a continuously variable transmission portion 105, a shift on the fly system 107 and a discrete transmission portion 109 to deliver the engine torque. The continuously variable transmission portion 105 includes a CVT primary drive clutch 104 that is rotationally coupled to a CVT secondary driven clutch 108 via belt 106 such as, but not limited to, a rubber belt. As known, the drive clutch 104 and the driven clutch 108 vary a rotational output of the driven clutch 108 based at least in part on the rotational speed of the drive clutch 104 and the torque transmitted by the driven clutch 108. The drive clutch 104 in an embodiment is operationally coupled to a crankshaft of the engine 102.

The shift on the fly system 107, includes a first input shaft 110, a disconnect clutch 112 and a second input shaft 114. The rotational output of the driven clutch 108 is operationally coupled to the first input shaft 110. The first input shaft 110 in turn is operationally coupled to the disconnect clutch 112. The disconnect clutch 112 is further operationally coupled to the second input shaft 114. In embodiments, as further discussed below in detail, the disconnect clutch 112 is activated to disconnect torque between the first input shaft 110 and the second input shaft 114 during a range ratio shift of the discrete transmission portion 109. In the embodiment of FIG. 1, the second input shaft 114 is operationally coupled to an input shaft high gear assembly and an input shaft low gear assembly. The input shaft high gear assembly includes an input shaft high gear 116, a reverse shaft high gear 118 and a high engagement dog/synchronizer 120. The input shaft low gear assembly includes an input shaft low gear 122, a reverse shaft low gear 124 and a low engagement dog/synchronizer 126. An output of the input shaft high gear assembly and the input shaft low gear assembly is provided to a reverse shaft 128, through miscellaneous gearing and the final drive 129 to the vehicle wheels 132. In one embodiment, in going from low gear range to high gear range, engine power is first reduced. The disconnect clutch 112 is then activated to disengage torque from the continuously variable transmission portion 105 of the CVT system 100 to the discrete transmission portion 109 of the CVT system 100. Low gear is first disengaged and then high gear is engaged. The disconnect clutch 112 is unactuated and then the engine power is restored. Moreover, in one embodiment, a high gear to low gear change includes reducing engine power. The disconnect clutch is then activated. High gear is then disengaged and then low gear is engaged. The disconnect clutch is then unactuated and the engine power is restored.

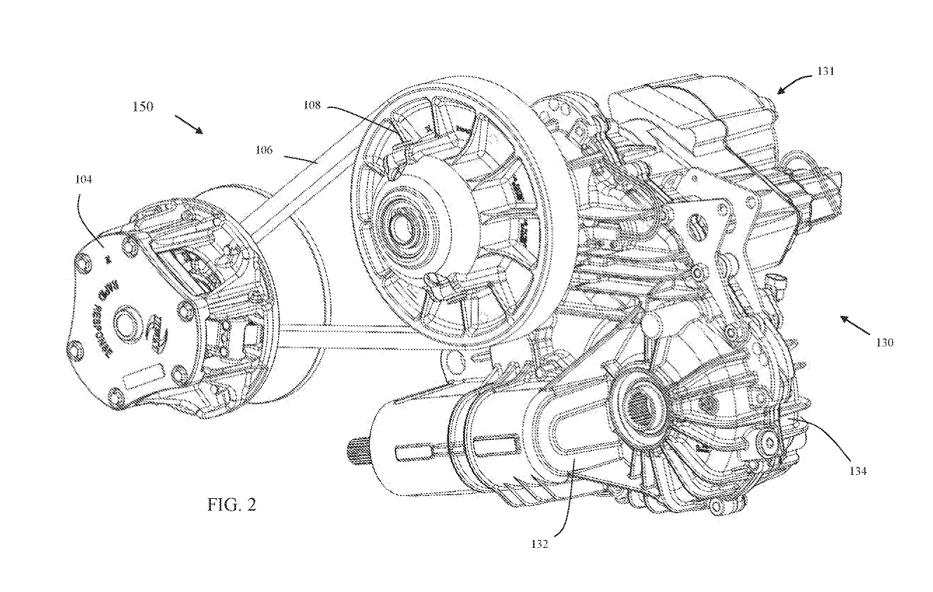

Referring to FIG. 2 an assembled CVT 150 of an embodiment is illustrated. The CVT 150 includes the drive clutch 104 which would be operationally coupled to an engine. The CVT 150 is illustrated as having a driven clutch 108 that is in rotational communication with the drive clutch 104 via belt 106. The drive clutch 104 and the driven clutch 108 make up the continuously variable portion of the transmission. In the example embodiment of FIG. 2, the CVT 150 includes a discrete transmission portion 130 with two gear ratios (high and low). Hence this portion of the transmission has discrete gear ratios. The discrete transmission portion 130 may be, but is not limited to, a transaxle, a transfer case or range box. FIG. 2 also illustrates a first transmission housing cover 132 coupled to a second transmission housing cover 134. The CVT 150 further includes a shift on the fly system. The location of the shift on the fly system is generally designated as 131 in FIG. 2.

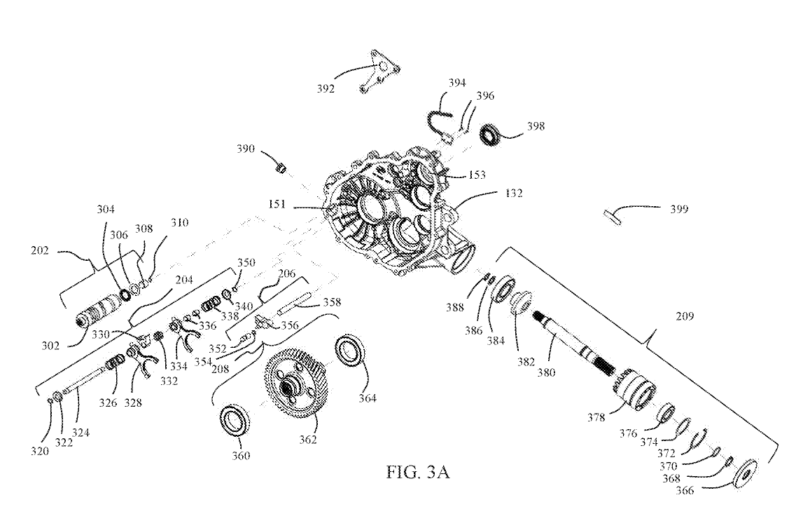

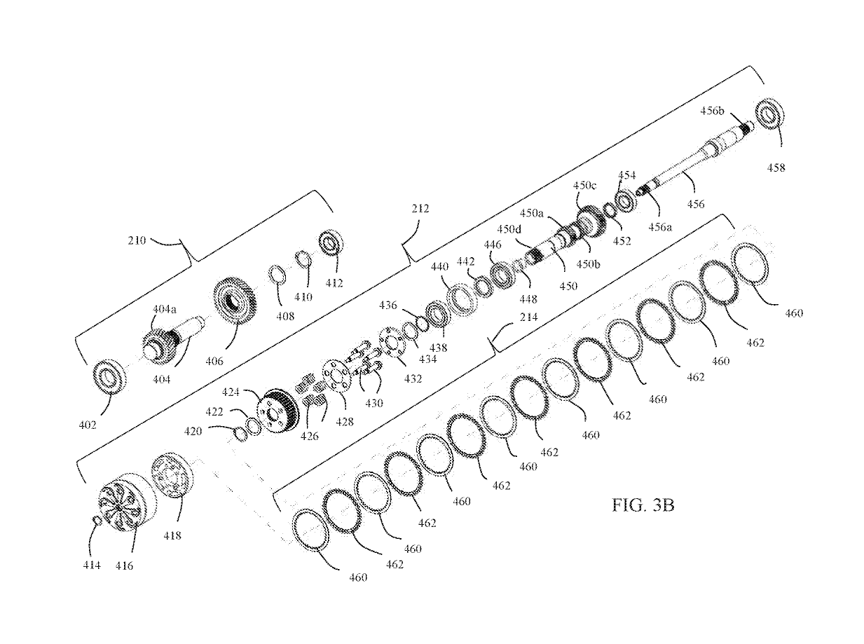

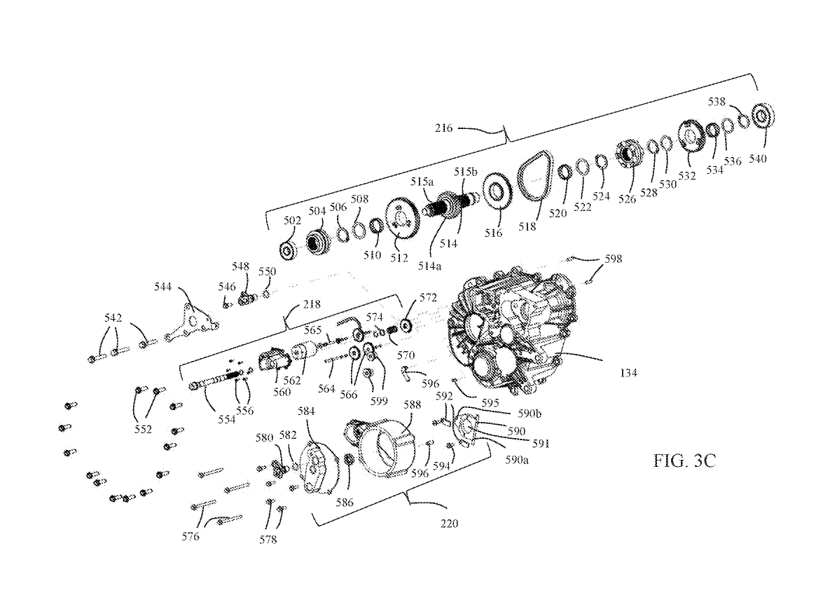

Components that make up the discrete transmission portion 130 (including the shift on the fly system) are illustrated in the exploded views of FIGS. 3A, 3B and 3C. Referring to FIG. 3A, the first transmission housing cover 132, a shift drum assembly 202, a shift fork assembly 204, a shift collar assembly 206, a first output assembly 208 and a second output assembly 209 are illustrated. The shift drum assembly 202 includes a shift drum 302, a bearing 304, a washer 306, a magnet holder insert 308 and a magnet 310. The shift fork assembly 204 includes a shift shaft rail 324 upon which is mounted a retaining ring 320, a washer 322, a compression spring 326, a first shift fork 328, a shift collar 330, a compression spring 332, a second shift fork 334, a pair of plain bearings 336, a compression spring 338, a washer 340 and a retaining ring 350. The shift collar assembly 206 includes a shift rail 358 upon which is slidably mounted a disconnect shift collar 356 and an O-ring 354. A push rod 352 extends from the disconnect shift collar 356 and engages a portion of the shift on the fly features described in detail below. The first output assembly 208 includes an output gear shaft 362 upon which is mounted on opposite sides of a shaft portion of the output gear shaft 362 a pair of ball bearings 360 and 364. The second output assembly 209 includes a front output shaft 380 upon which is mounted on one side a snorkel gear 382, a bearing 384, a washer 386 and a retaining ring 388. Mounted on another side of the front output shaft 380 is a snorkel tube 378, a bearing 376, a shim 374, a retaining ring 372, a shim 370, a retaining ring 368 and a seal 366. FIG. 3A further illustrates a plug 390 adapted to selectively fill an opening 151 in the first transmission housing cover 132, a rear mounted bracket 392 adapted to be attached to the first transmission housing cover 132, a sensor 394 adapted to be coupled to the first transmission housing cover 132 via fasteners 396, a label 399 and a seal 398 adapted to be received in an opening 153 in the first transmission housing cover 132 that is used to receive input shaft 456 further described in FIG. 3.

Referring to FIG. 3B, an idler shaft assembly 210, a shift on the fly clutch assembly 212 and a clutch friction plate assembly or clutch pack 214 of the shift on the fly system is illustrated. The idler shaft assembly 210 includes an idler shaft 404 with a stationary idler gear 404a upon which a bearing 402 is mounted. Also mounted on the idler shaft 404 is a second idler gear 406, a washer 408, a snap ring 410 and another bearing 412. The shift on the fly clutch assembly 212 includes an inner input shaft 456 (first input shaft) and an outer input shaft 450 (second input shaft). A portion of the inner input shaft 456 is received within the outer input shaft 450 as discussed and shown in detail below. The inner input shaft 456 includes first outer splines 456a proximate a first end of the inner input shaft 456 and second outer splines 456b proximate a second end of the inner input shaft 456. Mounted proximate the second end of the inner input shaft 456 is a bearing 458. Receive on the inner input shaft 456 is bearing 454 and seal 452. In addition, a flanged bushing 448 is received on a first end of the outer input shaft 450. The outer input shaft 450 includes a first gear 450a, a second gear 450b and third gear 450c. A first end of the output shaft 450 includes splines 450d. Mounted on the outer input shaft 450 is bearing 446, seal 442, thrust plate 440, thrust bearing 438, retaining ring 436, shim 434, pressure plate 432, thrust bolts 430, pressure plate 428, compression springs 426, an inner clutch basket 424, a shim 422 and a retaining ring 420. Further included in the shift on the fly clutch assembly 212 is a clutch pressure plate 418, and outer clutch basket 416, a retaining ring 414 and the clutch pack 214 that includes a plurality of clutch plates 460 and friction plates 462 that are described further in detail below.

FIG. 3C illustrates a shift assembly 216, an actuator assembly 218, a clutch cover assembly 220 and the second transmission housing cover 134. The shaft assembly 216 includes a reverse shaft 514. The reverse shaft 514 includes a central gear 514a and first and second outer spline shaft portions 515a and 515b. Mounted on the first spine shaft portion 515a is a low gear 512, a bearing 510, a washer 508, a snap ring 506, a low engagement dog 504 and a bearing 502. Mounted on the second spline shaft portion 515b is a sprocket 516 which is engaged with a chain 518, a bearing 520, a washer 522, a snap ring 524, an high/reverse engagement dog 526, a retaining ring 528, a washer 530, a high gear 532, a bearing 534, a washer 536, a retaining ring 538 and a bearing 540. The actuator assembly 218 includes a disconnect shaft 554, a motor cover 560, a motor 562 to change gearing, fasteners 556 to couple the motor cover 560 to the second transmission housing cover 134, a pinion shaft 565, a gear cluster 566, an idler shaft 564, washer 574 compression spring 570 and gear 572. The clutch cover assembly 220 includes a clutch cover 584 and a gear sector cover 588. A speed sensor 580 and O-ring 582 are coupled to the clutch cover 584 via fasteners 578. The gear section cover 588 is coupled to the second transmission housing cover 134 via bolts 576. Also illustrated is seal 586, tube vent 596 and disengagement fork 590 that is held in place via retainers 592 and fasteners 594. The disengagement fork 590 includes a disconnect pivot rod 590a proximate a first end, an activation portion 590b proximate a second end and a central passage 591 to receive the outer input shaft 450 discussed further below. Further illustrated in FIG. 3C is plugs 599, pin 595, tube vent 596 and dowel pins 598 used to align the second transmission housing cover 134 with the first transmission housing cover 132. Further, fasteners 552 are used to couple the second transmission housing cover 134 to the first transmission housing cover 132. Bracket 544 is also coupled to the second transmission housing cover 134 via fasteners 542. The discrete transmission portion 130 further includes a speed sensor 548 which along with an O-ring seal 550 is fastened to the second transmission housing with fastener 546 and is positioned to measure speed of the vehicle.

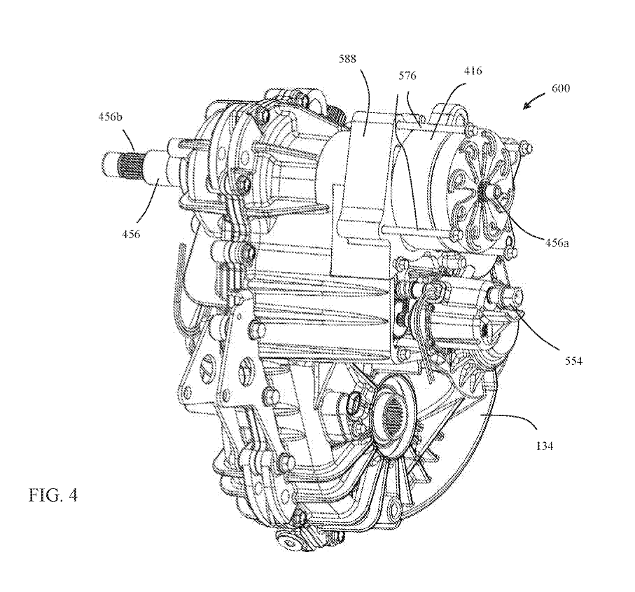

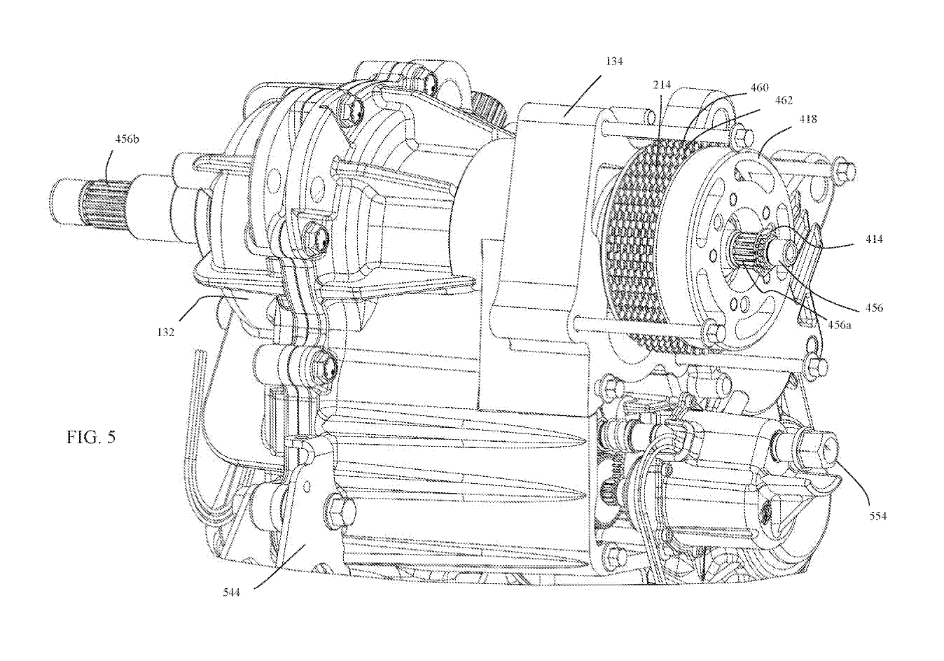

Referring to FIG. 4, a partial side perspective view of the discrete transmission portion 130 illustrates some of the shift on the fly features. In particular, FIG. 4 illustrates the outer clutch basket 416, the gear section cover 588, bolts 576 and the ends of the inner input shaft 456. FIG. 5 further illustrates the shift on the fly features without the outer clutch basket 416. FIG. 5 illustrates the clutch pressure plate 418 and the friction plates 462 and clutch plates 460 of the clutch pack 214. It also illustrates the retaining ring 414 engaged with the inner input shaft 456. In the embodiment, the retaining ring 414 is received in a retaining groove in the first outer splines 456a of the inner input shaft 456.

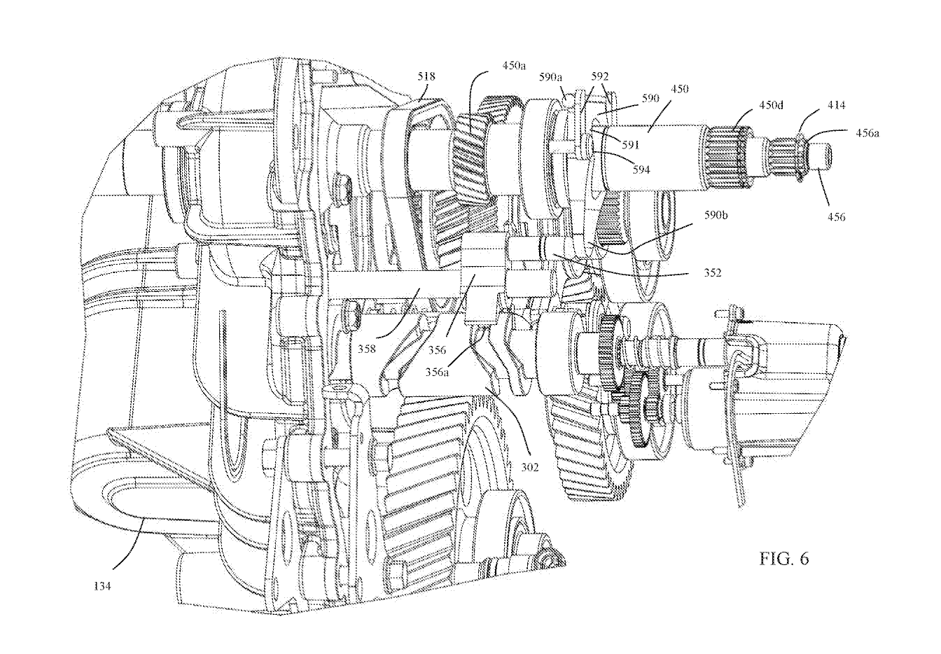

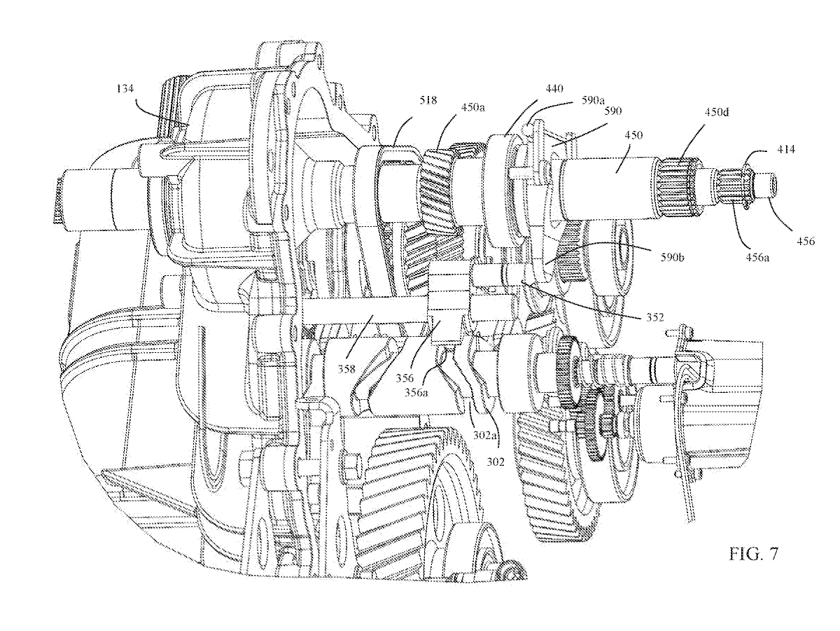

FIG. 6 further illustrates a portion of the inner input shaft 456 received within the outer input shaft 450. Also illustrated is splines 450d of the outer input shaft 450. Further illustrated is disengagement fork 590. As illustrated, the disengagement fork 590 is received around the outer input shaft 450 and held in place with the retainers 592 abutting the pivot rod 590a of the disengagement fork 590. The activation portion 590b of the disengagement fork 590 engages the push rod 352 that is coupled to the disconnect shift collar 356 that is in turn coupled to the shift rail 358. The disconnect shift collar 356 includes a track follower tab 356a that is received in a disconnect track 302a of the shift drum 302. Hence, movement of the shift drum 302 will cause the track follower tab 356a of the disconnect shift collar 356 to follow the disconnect track 302a which in turn will pivot the disengagement fork 590 as further discussed below. FIG. 7 further illustrates the portion off the shift on the fly features of FIG. 6 and at slightly different angle.

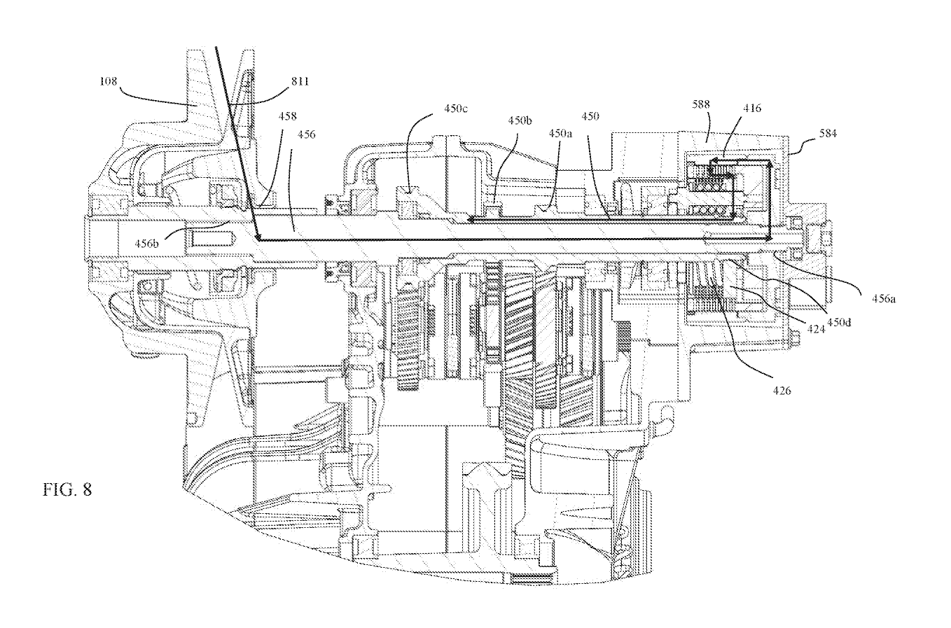

Referring to FIG. 8, a partial cross-sectional side view of the discrete transmission portion 130 with the driven clutch 108 operationally coupled to the inner input shaft 456 of an embodiment is illustrated. In particular, FIG. 8 illustrates a torque path 811 through the shift on the fly system. In particular, FIG. 8 illustrates how torque from the driven clutch 108 is transferred to the outer input shaft 450 of the shift on the fly system. As illustrated in FIG. 8, driven clutch 108 is coupled to the inner input shaft 456 with a spline interface connection using splines 456b of the inner input shaft 456. The torque is transferred to the outer clutch basket 416 with a spine interface connection using splines 456a of the inner input shaft 456. Torque is then transferred to the clutch pack 214. In particular, friction plates 462 of the clutch pack 214 engage an inner wall of the outer clutch basket 416. The sandwiched clutch plates 460 of the clutch pack 214 further engage the inner clutch basket 424 to transfer the torque to the inner clutch basket 424. The inner clutch basket 424 is connected to the outer input shaft 456 with a spline interface connection using the outer splines 450d of the outer input shaft 450. The torque is then provided to input shaft low gear 450a, input shaft reverse sprocket 450b and input shaft high gear 450c of the outer input shaft 450. Depending on the configuration of the shift assembly 216 as controlled by the shift drum assembly 202, the respective input shaft low gear 450a, input shaft reverse sprocket 450b and input shaft high gear 450c provides torque to the select gear configuration of the discrete transmission portion 130.

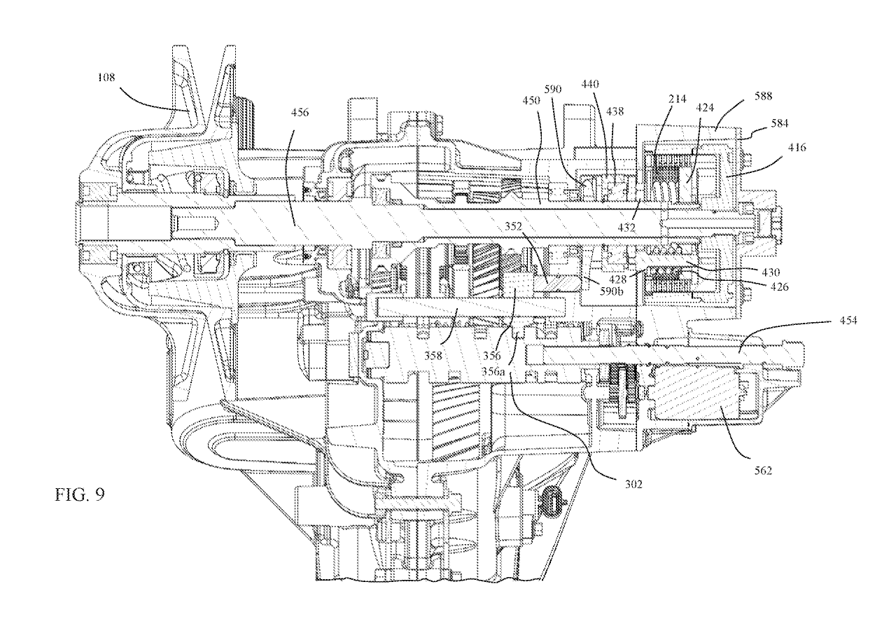

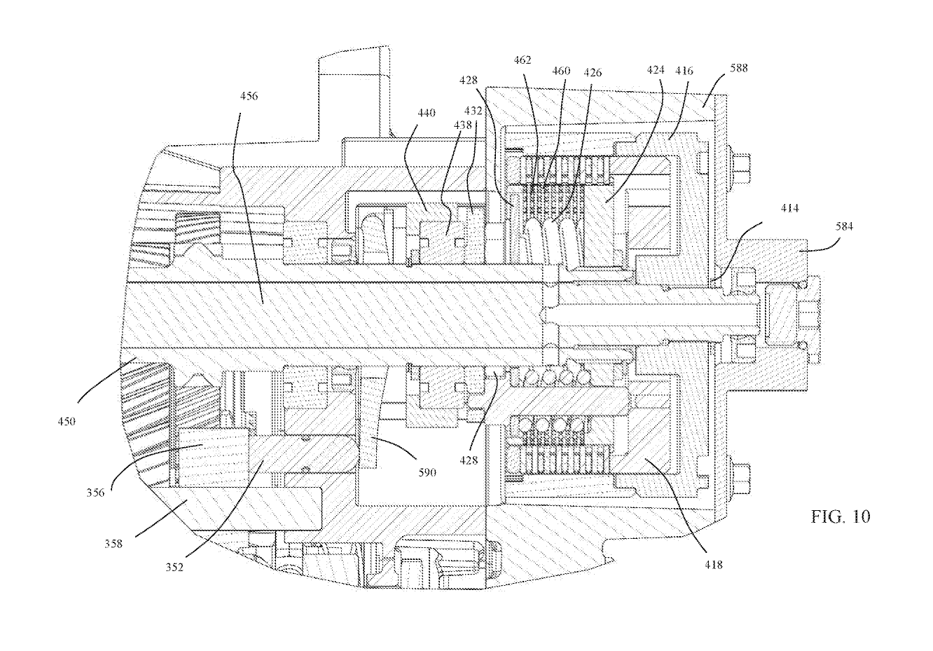

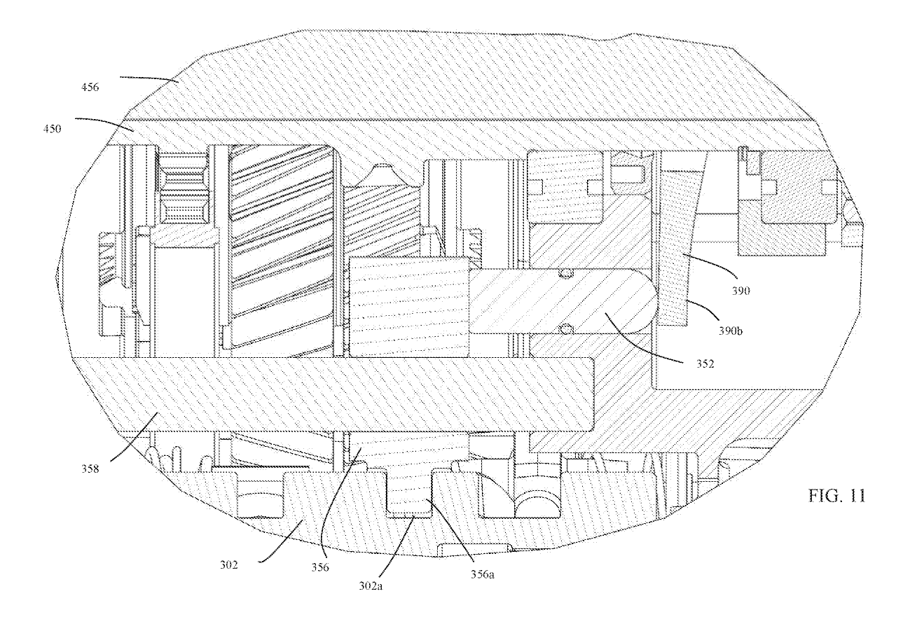

FIG. 9 provides a cross-sectional top view of the driven clutch and shift on the fly system. FIG. 9 further illustrates the track follower tab 356a of the disconnect shift collar 356 in a disconnect track of the shift drum 302. Also illustrated is the push rod 352 coupled to the disconnect shift collar 356. The push rod 352 in turn engages the activation portion 590b of the disengagement fork 590. When the disengagement fork 590 is pivoted, a force is asserted on the thrust plate 440 and thrust bearing 438 which counters the force of the compression springs 426. The compression springs provide the clutch pack pressure. When the compression springs 426 are compressed, the clutch pack pressure is released therein reducing pressure between the sandwiched clutch plates 460 and friction plates 462. This action disconnects torque from the inner input shaft 456 to the outer input shaft 450. FIG. 10 is a partial close up view of a portion of the shift on the fly system further illustrating the disengagement fork 590, the thrust plate 440, trust bearing 438, pressure plate 432 and pressure plate 428. FIG. 11 further provides a close up view of the track follower tab 356a of the disconnect shift collar 356 in a disconnect track 302a of the shift drum 302. Also illustrated is the push rod 352 coupled to the disconnect shift collar 356. The push rod 352 in turn engages the activation portion 590b of the disengagement fork 590.

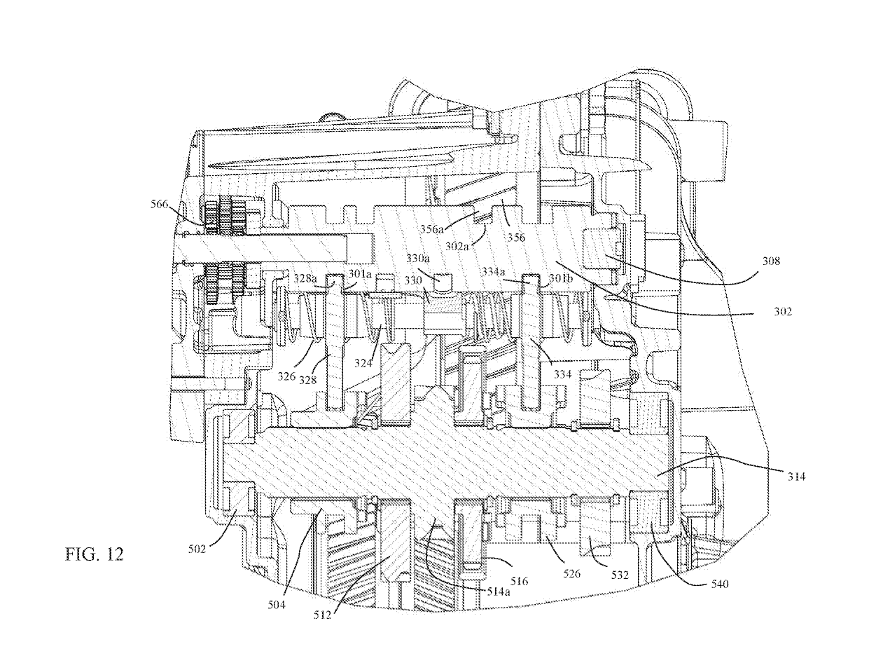

FIG. 12 illustrates another portion of the discrete transmission portion 109. FIG. 12 illustrates the shift drum 302 having the track follower tab 356a of the disconnect shift collar 356 in the disconnect track 302a as discussed above. FIG. 12 also illustrates the shift drum have a plurality of shift tracks 301 that are configured to receive a shift tab 328a of shift fork 328, shift tab 330a of shift collar 330 and shift tab 334a of shift fork 334. Shift fork 328 is engaged with low engagement shift dog 504 and shift fork 334 is engaged with high/reverse engagement shift dog 526 which are both respectfully slidably engaged to the reverse shaft 314. Hence movement by the shift drum 302, controls the shifting of the gearing of the discrete transmission portion 109 as well the disconnect clutch 112. In embodiments, the disconnect track 302a and the shift tracks 301 (including shift tracks 301a and 301b) are designed to that the disconnect clutch 112 is activated during a range ratio shift as discussed further below.

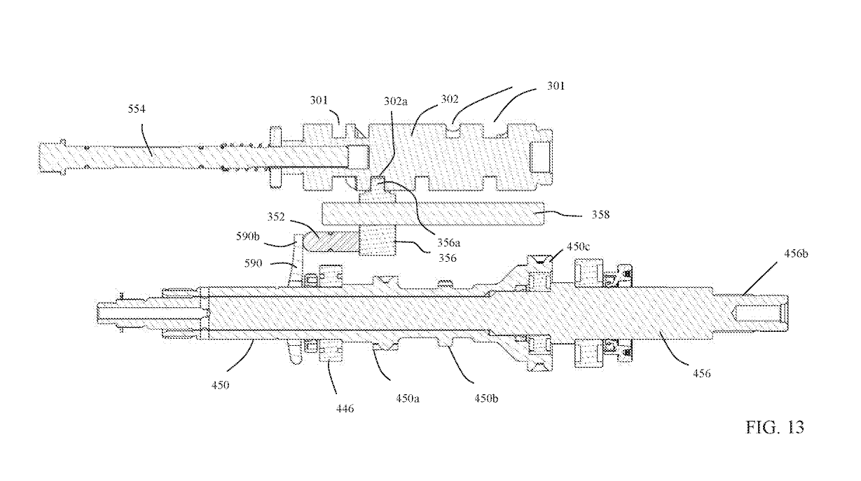

FIG. 13 is a cross-sectional view of the partial components of the shift on the fly system of an embodiment. In particular, FIG. 13 illustrates the shift drum 302 and the disconnect shaft 554 that allows for the manual movement of the shift drum 302 in the event of a power failure. The shift drum 302 is illustrated as having shift tracks 301 has discussed above are used to switch gearing of the discrete transmission portion 109. The shift drum 302 is further illustrated as having the disconnect track 302a in which the track follower tab 356a of the disconnect shift collar 356 is received. The disconnect shift collar 356 is mounted on the disconnect shift rail 358. The push rod 352 extends from the disconnect shift collar 356 and engages the activation portion 590b of the pivotally coupled disengagement fork 590 that is mounted on the outer input shaft 450. As discussed above, the pivoting of the disengagement fork 590 reduces friction between friction plates 462 and the clutch plates 460 of the clutch pack 214 therein disconnection torque between the inner input shaft 456 and the outer input shaft 450.

A low to high gear change overview of an embodiment in light of the embodiments illustrated in FIGS. 1-13 is herein provided. The CVT 150 initially in low range includes the shift drum 302 being rotated to a position such that a respective shift drum track 301a engages the low engagement dog 504 with the low gear 512, while the high/reverse engagement shift dog 526 is disengaged with both the reverse shaft sprocket 516 and the reverse shaft high gear 532 and positions the disconnect shift collar 356 to a position that does not provide an axial force on the push rod 352 and therefor dictates that the disconnect clutch 112 is not activated and thus able to transmit torque. In initiating the low to high shift, the shift drum 302 begins to rotate from a “low” position to the “high” position. The disconnect track 302a of the shift drum 302 causes axial movement of the disconnect shift collar 356 which through push rod 352, disengagement fork 590, axial thrust collar 440, thrust bearing 438, axial thrust plate 432, axial thrust bolts 430 and pressure plate 428 causes the disconnect clutch 112 to activate to disconnect the transfer of torque. Respective shift track 301a causes axial movement of the low shift fork 328 which causes movement of the low engagement dog 504 resulting in the disengagement of the low engagement dog 504 from the reverse shaft low gear 512. In alternative embodiments synchronizers are used instead of the engagement dogs.

Shift drum track 301b further causes axial movement of the high/reverse shift fork 334 which causes axial movement of the high/reverse engagement dog 526 resulting in the engagement of the high/reverse engagement dog 526 to reverse shaft high gear 532. In addition, the disconnect track 302a of the shift drum 302 causes axial movement of the disconnect shift collar 356 which causes the disconnect clutch 112 to un-activate to reengage the torque due the axial force of the clutch engagement springs 426. During the engagement of the disconnect clutch 112, the rotational speed of the input shaft 456 and the driven clutch 108 is synchronized with the rest of the transmission 150. As this engagement is accomplished with the friction style clutch in embodiments, rather than a dog style engagement clutch, the energy required for speed synchronization is spread out in time compared to that of a dog clutch engagement therein resulting in the minimizing of “clunk.”

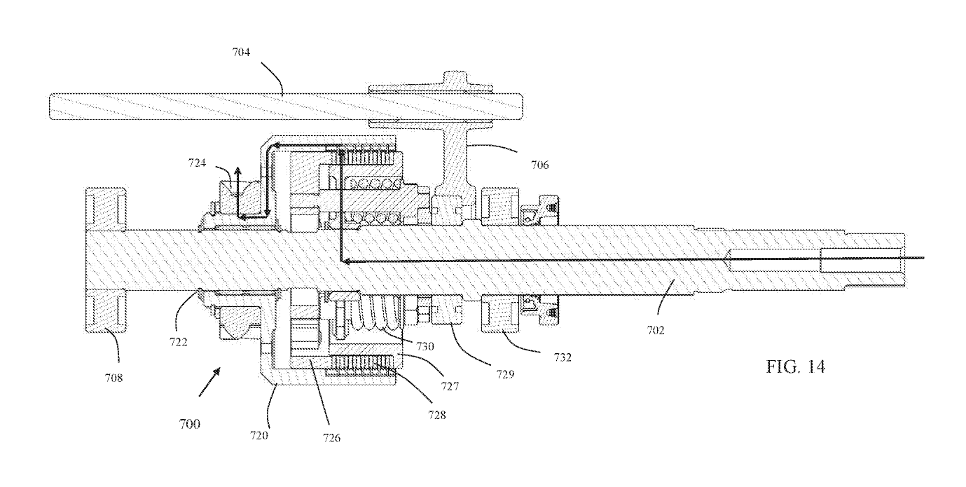

FIG. 14 illustrates an alternative shift on the fly system 700. In this embodiment, only one input shaft 702 with one gear 724 is used. A shaft containing multiple gear and shifting is further positioned downstream in the transmission system of this embodiment. In this embodiment, the shifting is done with a disconnect shift fork 706 actuated by the shift drum (not shown) acting directly on the thrust bearing 729. This embodiment includes a disengagement shift rail 704 upon which a disconnect shift fork 706 is mounted. The disconnect shift fork 706 is further engaged with the thrust bearing 729. Similar to the embodiment discussed above, the shift on the fly assembly includes an inner ring clutch basket 727, compression springs 730, an outer clutch basket 720 and a clutch pack 728. The clutch pack includes a plurality of sandwiched friction plates and clutch plates. The friction plates are coupled to the outer clutch basket 720 and the clutch plates are coupled to the inner ring clutch basket 727. Movement of the thrust bearing 729 into the clutch basket 720 reduces friction between the friction plates and clutch plates therein ceasing torque from the inner ring clutch basket 727 to be transferred to the outer clutch basket 720. As illustrated, the outer clutch basket 720 is directly coupled to the gear 724. FIG. 14 further illustrates how input torque flows through to the only gear 724. As illustrated, torque enters the shaft 702 as the result of the shaft being coupled to a drive clutch or the like. The torque is passed through the inner ring clutch basket 727, through the clutch pack 728 to the outer clutch basket 720. Since, the outer clutch basket 720 is directly coupled to the only gear 724, the torque is passed to the only gear 724. FIG. 14 further illustrates bearings 708 and 732 mounted on the shaft 702 and clutch pressure plate 726 and retaining clip 722.

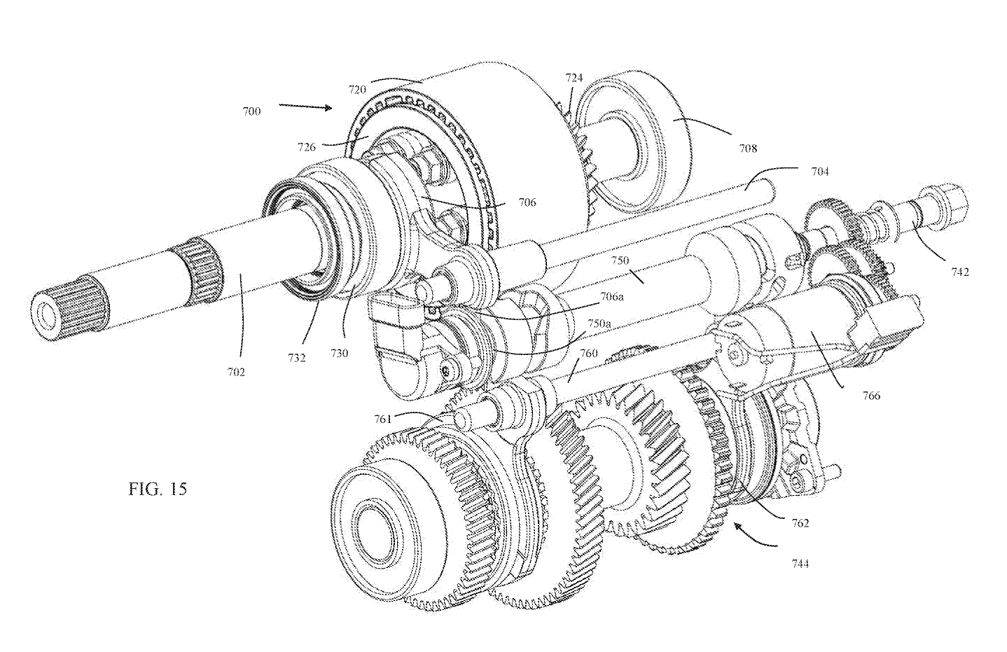

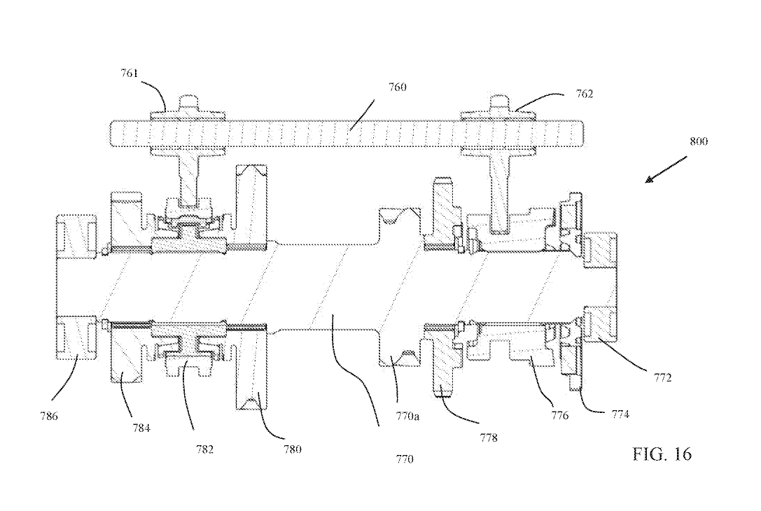

FIG. 15 illustrates a side perspective view of the shift on the fly embodiment of FIG. 14. As illustrated, the disconnect shift fork 706 has a disconnect tab 706a that is received directly in a disconnect track 750a of a shift drum 750. The shift drum is rotated by an electric motor 766 to change the gearing of the transmission. This embodiment also includes a manual override 742 if power is lost and the gearing needs to be changed. As further illustrated in FIG. 15, shift forks 761 and 762 are operationally coupled in shift tracks of the shift drum 750. As in the above embodiment, movement of the shift forks moves respective shift dogs to change gearing 744. FIG. 16 illustrates the shift shaft rail 760 upon which the shift forks 761 and 762 are mounted. FIG. 16 also illustrates a reverse shaft 770. In one embodiment, the reverse shaft include a central gear 770a. Mounted on the reverse shaft 770 is a bearing 772, park plate 774, high engagement dog 776, sprocket 778, low gear 780, low engagement dog 782, high gear 784 and bearing 786.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A shift on the fly transmission comprising:
a continuously variable transmission portion operationally coupled to receive torque from an engine;
a discrete transmission portion having a gear assembly;
at least one input shaft operationally coupled to an output of the continuously variable transmission portion; and
a disconnect clutch operationally coupling the at least one input shaft to the discrete transmission portion, the disconnect clutch configured to selectively decouple torque from the at least one input shaft to the discrete transmission portion during a range ratio shift of the discrete transmission portion.

2. The shift on the fly transmission of claim 1, wherein the at least one input shaft further comprises:
a first input shaft operationally coupled to an output of the continuously variable transmission portion;
a second input shaft operationally coupled to the discrete transmission portion; and
the disconnect clutch operationally coupling the at least one input shaft to the second input shaft.

3. The shift on the fly transmission of claim 2, wherein the first input shaft is an inner input shaft and the second input shaft is an outer input shaft, the inner input shaft received within the outer input shaft.

4. The shift on the fly transmission of claim 1, wherein the disconnect clutch includes a clutch pack.

5. The shift on the fly transmission of claim 1, further comprising:
a shift drum having a disconnect track; and
a disengagement fork operationally engaged with the disconnect track of the shift drum, the disengagement fork further configured to activate the disconnect clutch.

6. The shift on the fly transmission of claim 5, further comprising:
the disengagement fork pivotally coupled to the at least one input shaft.

7. The shift on the fly transmission of claim 1, wherein the continuously variable transmission portion further comprises:
a drive clutch operationally coupled to receive the torque from the engine in the form of a rotational input;
a driven clutch, the at least one input shaft operationally coupled to the driven clutch; and
a belt engaged between the drive clutch and the driven clutch to rotationally couple the drive clutch to the driven clutch.

8. The shift on the fly transmission of claim 1, wherein the gear assembly of the discrete transmission portion further comprises:
an input shaft high gear assembly; and
an input shaft low gear assembly.

9. The shift on the fly transmission of claim 8, further comprising:
the input shaft high gear assembly including,
an input shaft high gear,
a reverse shaft high gear, and
an engagement dog; and
the input shaft low gear assembly including:
an input shaft low gear,
reverse shaft low gear, and
engagement dog; and:
a reverse shaft operationally coupled between the gear assembly and the final drive.

10. A shift on the fly transmission comprising:
a drive clutch operationally coupled to receive torque from an engine in the form of a rotational input;
a driven clutch;
a belt engaged between the drive clutch and the driven clutch to rotationally couple the drive clutch to the driven clutch;
an inner input shaft operationally coupled to the driven clutch;
a discrete transmission portion having a gear assembly;
an outer input shaft operationally coupled to the discrete transmission; and
a disconnect clutch operationally coupling the inner input shaft to the outer input shaft, the disconnect clutch configured to selectively decouple torque from the inner input shaft to the outer input shaft during a range ratio shift of the discrete transmission portion.

11. The shift on the fly transmission of claim 10, the discrete transmission portion further comprising:
a shift drum having a disconnect track;
a disconnect shift collar operationally engaged in the disconnect track of the shift drum;
a push rod operationally coupled to the disconnect shift collar; and
a disengagement fork operationally engaged with the push rod, the disengagement fork further configured and arranged to activate the disconnect clutch.

12. The shift on the fly transmission of claim 11, wherein the disconnect clutch further comprises:
an inner ring clutch basket operationally coupled to the outer input shaft;
an outer clutch basket operationally coupled to the inner input shaft; and
a clutch pack including a plurality sandwiched clutch plates and friction plates, the clutch plates engaged with the inner ring basket and the friction plates engaged with the outer clutch basket, wherein activation of the disconnect clutch reduces friction between the sandwiched clutch plates and friction plates.

13. The shift on the fly transmission of claim 12, further comprising:
at least one pressure plate configured and arranged to operationally engage the clutch pack; and
a plurality of compression springs operationally engaged with the at least one pressure plate to compress the sandwiched clutch plates and friction plates of the clutch pack, the disengagement fork configured to selectively compress the plurality of springs to disengage the disconnect clutch.

14. A vehicle having a shift on the fly transmission system, the vehicle comprising:
an engine to provide torque;
a continuously variable transmission portion operationally coupled to the engine to receive the torque;
a discrete transmission portion having a gear assembly;
at least one input shaft operationally coupled to the continuously variable transmission portion;
a disconnect clutch operationally coupling the at least one input shaft to the discrete transmission portion, the disconnect clutch further configured and arranged to selectively decouple torque from the at least one input shaft to the discrete transmission portion;
a final drive assembly operationally coupled to an output of the discrete transmission; and
at least one vehicle wheel operationally coupled to the final drive assembly.

15. The vehicle of claim 14, wherein the at least one input shaft further comprises:
a first input shaft operationally coupled to an output of the continuously variable transmission portion;
a second input shaft operationally coupled to the discrete transmission portion; and
the disconnect clutch operationally coupling the at least one input shaft to the second input shaft.

16. The vehicle of claim 14, wherein the first input shaft is an inner input shaft and the second input shaft is an outer input shaft, the inner input shaft received within the outer input shaft.

17. The vehicle of claim 14, further comprising:
a shift drum having a disconnect track;
a disconnect shift collar operationally engaged in the disconnect track of the shift drum;
a push rod operationally coupled to the disconnect shift collar; and
a disengagement fork operationally engaged with the push rod, the disengagement fork further configured and arranged to activate the disconnect clutch.

18. The vehicle of claim 14, wherein the continuously variable transmission further comprises:
a drive clutch operationally coupled to receive the torque of the engine in the form of a rotational input;
a driven clutch, the at least one input shaft operationally coupled to the driven clutch; and
a belt engaged between the drive clutch and the driven clutch to rotationally couple the drive clutch to the driven clutch.

19. The vehicle of claim 14, wherein the gear assembly further comprises:
an input shaft high gear assembly; and
an input shaft low gear assembly.

20. The vehicle of claim 14, further comprising:
the input shaft high gear assembly including,
an input shaft high gear,
a reverse shaft high gear, and
at least one of a high engagement dog and a high synchronizer;
the input shaft low gear assembly including:
an input shaft low gear,
reverse shaft low gear, and
at least one of a low engagement dog and a low synchronizer; and
a reverse shaft operationally coupled between the gear assembly and the final drive.
